(19) United States
(12) Patent Application Publication
(10) Pub. No.: US 2026/0143311 A1
(43) Pub. Date: May 21, 2026

(54) SYSTEMS AND METHODS FOR GEOLOCATING A DEVICE

(71) Applicant: RESIDEO LLC, Golden Valley, MN (US)

(72) Inventors: Andrew Blohm, Washington, DC (US); James T. Woolaway, Carbondale, CO (US)

(73) Assignee: RESIDEO LLC, Golden Valley, MN (US)

(21) Appl. No.: 19/122,463

(22) PCT Filed: Oct. 20, 2023
(86) PCT No.: PCT/US2023/077388

§ 371 Date: Apr. 18, 2025

Related U.S. Application Data
(60) Provisional application No. 63/380,267, filed on Oct. 20, 2022.

(51) Int. Cl. H04W 4/38; H04W 64/00

(52) U.S. Cl. CPC H04W 4/38; H04W 64/00

(57) ABSTRACT

Systems and methods enable geolocation based on environmental conditions using a processor. The processor receives environmental sensor data from an environmental sensor associated with Internet-of-Things (IoT) device. The processor generates an environmental sensor signature representing variation of characteristic of the environmental sensor data over a period of time and accesses environmental data for a meteorological condition in a region over the period time. The processor utilizes a data model to determine, based at least in part on the variation of the characteristic of the environmental sensor data, a degree of correlation between the environmental data at each geographic location in the region, and the environmental sensor signature. The processor determines a particular geographic location having a greatest correlation to the environmental sensor signature to assign as the geolocation of the IoT device.

### CROSS REFERENCE TO RELATED APPLICATION

This application claims the benefit of, and priority to, U.S. Provisional Patent Application No. 63/380,267 filed Oct. 20, 2022, the entirety of which is incorporated herein by reference.

### TECHNICAL FIELD

This disclosure relates to methods and systems for geolocating a device, including establishing the geolocation of electronic control systems in residential and commercial environments.

### BACKGROUND

Modern electronic control systems are used in a wide variety of applications contained within homes, businesses, and structures. Some examples of these systems include Thermostats, Heating, Ventilation and Air Conditioning (HVAC) controllers, and Smart Home controllers which can sense and control a wide range of applications in the home. These systems often have a feature allowing an end user to input the controller's location such as the zip code, or more specific location information such as the longitude and latitude. This information is important as modern and emerging controllers contain algorithms that improve the performance of the controlled system by using data related to the location of the unit. This is projected to be even more critical for emerging controller systems. Generally, exact location or absolute location information is not needed, and general location information accurate to within a 1 mile or 1.5 km range is adequate. In some cases, not having location information more precise than this, is preferred as it reduces the concern that some people have about their location information being miss used. Without general location information, the algorithms contained within the controllers, cannot make as efficient control decisions based on the inaccurate location data.

In practice, for systems that request the user to input location information into the controller, the information is often not entered or is input to misrepresent the actual location of the unit. This therefore defeats the algorithms that optimize the controller efficiency based on geographic location.

### SUMMARY OF THE DISCLOSURE

Described here are systems and methods that allow electronic control systems, located within homes, businesses, and structures to determine their approximate geographic locations by using atmospheric pressure data and sensors. Modern and emerging control systems are integrating algorithms that improve the efficiency and performance of the systems that the control systems are controlling. These algorithms often benefit from knowing approximately where the system is geographically located. The geographic location enables the control system to access and integrate into calculations, data that is related to their location. Data examples can include any data that would be geographically related such as weather data, pressure data, power grid data, and power cost data.

Embodiments of the present disclosure generate an approximate geographic location through the incorporation of a pressure sensor in the controller product and by performing algorithmic processing of its data against externally sourced weather data. The controller pressure sensor may be sampled periodically, and the sampled data compared to pressure data as established by external organizations such as, e.g., the National Oceanic and Atmospheric Administration (NOAA), National Weather Service (NWS), among others or any combination thereof. Algorithmic correlation between data sampled locally at the controller, and atmospheric data, may be refined over time through repeated data samplings and correlations, yielding the most probable location for the controller.

The combination of the pressure sensor, atmospheric pressure data, and algorithms integral to the controller device allows for the unique ability for the controller device to determine its approximate location over time, thus allowing additional algorithms that use location data for providing performance advantages to function properly, provide operational advantages, and performance benefits.

Embodiments of the disclosure provide systems and methods for establishing the approximate geographic location of a controller without user intervention. Most homes, businesses, and structures contain one or more controllers such as thermostats, HVAC system controllers, water heater controllers, and others. Modern controllers and emerging controllers use algorithms to improve their performance and efficiencies. For these and emerging algorithms to provide more efficient results for their respective control function, location data can be important.

Disclosed herein are one or more embodiments of a method and/or system of using a pressure sensor integral to the controller, atmospheric weather data, and an algorithmic process to determine over time the approximate location of the controller. The process can therefore be conducted without user intervention and can provide a high degree of certainty that the controller will have an approximate geographic location for use in optimizing performance.

### BRIEF DESCRIPTION OF DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 illustrates a computer-based geolocating system for environmental measurement-based geolocation determination in accordance with one or more embodiments of the present disclosure.

FIG. 2 illustrates an environmental measurement device for environmental measurement-based geolocation determination in accordance with one or more embodiments of the present disclosure.

FIG. 3 illustrates environmental measurement-based geolocation determination using the computer-based geolocating system in accordance with one or more embodiments of the present disclosure.

FIG. 4 is a diagram illustrating a map of a geographic region including the contiguous 48 states of the United States of America (“the US”) over laid with Isobar lines indicating pressures across the geographic region at a first time in accordance with one or more embodiments of the present disclosure.

FIG. 5 is a diagram illustrating a map of a geographic region including the contiguous 48 states of the United States of America (“the US”) over laid with Isobar lines indicating pressures across the geographic region and highlighting matching Isobar lines at the first time in accordance with one or more embodiments of the present disclosure.

FIG. 6 is a diagram illustrating a map of a geographic region including the contiguous 48 states of the United States of America (“the US”) over laid with Isobar lines indicating pressures across the geographic region and highlighting matching Isobar lines at a second time in accordance with one or more embodiments of the present disclosure.

FIG. 7 is a diagram illustrating geolocation candidates at the second time based on the matching Isobar lines in the geographic region in accordance with one or more embodiments of the present disclosure.

FIG. 8 is a diagram illustrating geolocation candidates at a third time based on the matching Isobar lines in the geographic region in accordance with one or more embodiments of the present disclosure.

FIG. 9 is a graph showing atmospheric pressure changes at three locations L1, L2 and L3 in accordance with one or more embodiments of the present disclosure.

FIG. 10 depicts a block diagram of an exemplary computer-based system and platform for environmental measurement-based geolocation determination in accordance with one or more embodiments of the present disclosure.

FIG. 11 depicts a block diagram of another exemplary computer-based system and platform for environmental measurement-based geolocation determination in accordance with one or more embodiments of the present disclosure.

FIG. 12 depicts illustrative schematics of an exemplary implementation of the cloud computing/architecture(s) in which embodiments of a system for environmental measurement-based geolocation determination may be specifically configured to operate in accordance with some embodiments of the present disclosure.

FIG. 13 depicts illustrative schematics of another exemplary implementation of the cloud computing/architecture(s) in which embodiments of a system for environmental measurement-based geolocation determination may be specifically configured to operate in accordance with some embodiments of the present disclosure.

### DETAILED DESCRIPTION

Various detailed embodiments of the present disclosure, taken in conjunction with the accompanying FIGS., are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and” In either case, the set is to be interpreted as meaning each of the items singularly as alternatives, as well as any combination of the listed items.

The use of electronic controllers for various systems are becoming increasingly common in the home and in commercial environments. Modern controllers are often incorporating algorithms that allow their performance characteristics to be improved by incorporating geographic data. Often this geographic data is dynamic and changing, therefore requiring this data to be updated periodically from the data source by way of the internet and data cloud. For the controller to take advantage of the geographic data. the controller needs to have its approximate location. As new and more advanced controllers are developed, some targeted at aggregating data from many sensors in many systems and actuating and controlling a wide range of responses to this data, the need for geolocation data is becoming more important.

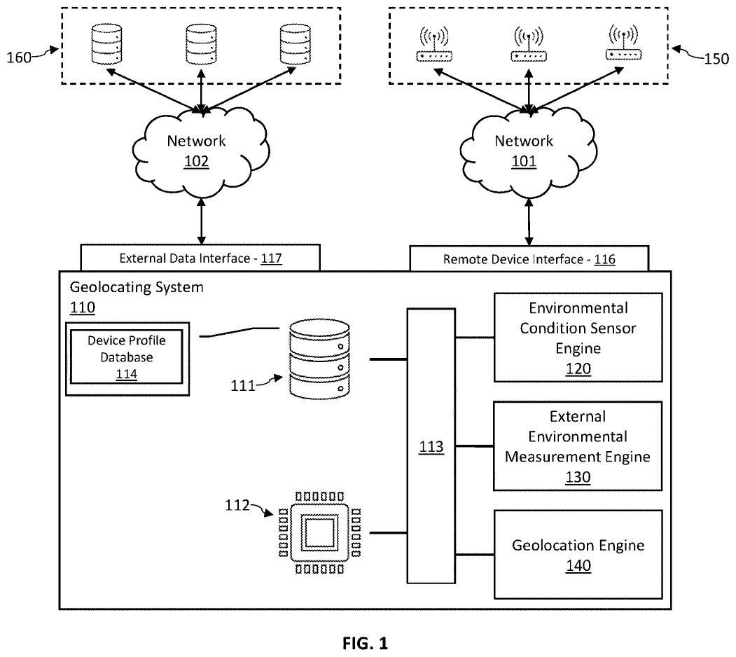

FIGS. 1 through 13 illustrate systems and methods of determining an approximate location of a device by cross-referencing one or more environmental measurements with externally published environmental and/or meteorological data across pertaining to a region. The following embodiments provide technical solutions and technical improvements that overcome technical problems, drawbacks and/or deficiencies in the technical fields involving obtaining accurate location data for a device without access to a global positioning system (GPS) or other positioning system. As explained in more detail, below, technical solutions and technical improvements herein include aspects of improved location determination that can acquire an approximate geolocation of a device even where GPS (or other positioning system) data is unavailable and/or where a user fails to manually enter location data. Accordingly, one or more embodiments of the present disclosure provide technical solutions that integrate a pressure sensor, atmospheric pressure data, processor and processing algorithm into a controller, compare the pressure data measured at the controller to a database of global or continental atmospheric pressure data, algorithmically derive the approximate location of the controller from data obtained from a pressure sensor located within the controller and regional weather data, use pressure data to develop location correlations without user intervention, and/or develop an estimate of the controller location through successive samplings and correlations.

Based on such technical features, further technical benefits become available to users and operators of these systems and methods. Moreover, various practical applications of the disclosed technology are also described, which provide further practical benefits to users and operators that are also new and useful improvements in the art.

FIG. 1 illustrates a computer-based geolocating system for environmental measurement-based geolocation determination in accordance with one or more embodiments of the present disclosure.

In some embodiments, to provide geolocating capability without GPS and/or wireless triangulation techniques, a geolocating system 110 may include an external data interface 117 to access regional environmental condition data, such as, e.g., meteorological data, weather data, ground measurements, or other suitable regional data indicative of environmental conditions across a region. The external data interface 117 may interface with one or more external regional environmental condition data sources 160, e.g., via a network 102. Additionally, the geolocating system 110 may interface, e.g., via a network 101, with one or more environmental sensor devices 150 associated with one or more locations, users and/or devices at particular locations within the region to obtain environment condition sensor data measured by the one or more environmental sensor devices 150 at the one or more locations. In some embodiments, the geolocating system 110 may use a local sensor measurement engine 120, an external environmental measurement engine 130 and a geolocation engine 140 to determine a geolocation of the one or more environmental sensor devices 150 based on the environmental sensor data and the regional environmental condition data.

In some embodiments, one or more interfaces may utilize one or more software computing interface technologies, such as, e.g., Common Object Request Broker Architecture (CORBA), an application programming interface (API) and/or application binary interface (ABI), among others or any combination thereof. In some embodiments, an API and/or ABI defines the kinds of calls or requests that can be made, how to make the calls, the data formats that should be used, the conventions to follow, among other requirements and constraints. An “application programming interface” or “API” can be entirely custom, specific to a component, or designed based on an industry-standard to ensure interoperability to enable modular programming through information hiding, allowing users to use the interface independently of the implementation. In some embodiments, CORBA may normalize the method-call semantics between application objects residing either in the same address-space (application) or in remote address-spaces (same host, or remote host on a network).

In some embodiments, one or more interfaces may utilize one or more hardware computing interface technologies, such as, e.g., Universal Serial Bus (USB), IEEE 1394 (FireWire), Ethernet, Thunderbolt™, Serial ATA (SATA) (including eSATA, SATAe, SATAp, etc.), among others or any suitable combination thereof.

In some embodiments, the network may include any suitable computer network, including, two or more computers that are connected with one another for the purpose of communicating data electronically. In some embodiments, the network may include a suitable network type, such as, e.g., a public switched telephone network (PTSN), an integrated services digital network (ISDN), a private branch exchange (PBX), a wireless and/or cellular telephone network, a computer network including a local-area network (LAN), a wide-area network (WAN) or other suitable computer network, or any other suitable network or any combination thereof. In some embodiments, a LAN may connect computers and peripheral devices in a physical area by means of links (wires, Ethernet cables, fiber optics, wireless such as Wi-Fi, etc.) that transmit data. In some embodiments, a LAN may include two or more personal computers, printers, and high-capacity disk-storage devices, file servers, or other devices or any combination thereof. LAN operating system software, which interprets input and instructs networked devices, may enable communication between devices to: share the printers and storage equipment, simultaneously access centrally located processors, data, or programs (instruction sets), and other functionalities. Devices on a LAN may also access other LANs or connect to one or more WANs. In some embodiments, a WAN may connect computers and smaller networks to larger networks over greater geographic areas. A WAN may link the computers by means of cables, optical fibers, or satellites, cellular data networks, or other wide-area connection means. In some embodiments, an example of a WAN may include the Internet. In some embodiments, network 101 and network 102 may be the same or different networks or may be sub-networks for a larger WAN.

In some embodiments, the geolocating system 110 may include hardware components such as a processor 111, which may include local or remote processing components. In some embodiments, the processor 111 may include any type of data processing capacity, such as a hardware logic circuit, for example an application specific integrated circuit (ASIC) and a programmable logic, or such as a computing device, for example, a microcomputer or microcontroller that include a programmable microprocessor. In some embodiments, the processor 111 may include data-processing capacity provided by the microprocessor. In some embodiments, the microprocessor may include memory, processing, interface resources, controllers, and counters. In some embodiments, the microprocessor may also include one or more programs stored in memory.

Similarly, the geolocating system 110 may include storage 112, such as one or more local and/or remote data storage solutions such as, e.g., local hard-drive, solid-state drive, flash drive, database or other local data storage solutions or any combination thereof, and/or remote data storage solutions such as a server, mainframe, database or cloud services, distributed database or other suitable data storage solutions or any combination thereof. In some embodiments, the storage 112 may include, e.g., a suitable non-transient computer readable medium such as, e.g., random access memory (RAM), read only memory (ROM), one or more buffers and/or caches, among other memory devices or any combination thereof.

In some embodiments, the geolocating system 110 may implement computer engines for processing regional environmental condition data from the external regional environmental condition data sources 160, processing the environment condition sensor data from the one or more environmental sensor devices 150, and geolocating the one or more environmental sensor devices 150 based on the regional environmental condition data and the environment condition sensor data. In some embodiments, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

In some embodiments, to process the environmental condition sensor data, the geolocating system 110 may include computer engines including. e.g., an environmental condition sensor engine 120. In some embodiments, the environmental condition sensor engine 120 may include dedicated and/or shared software components, hardware components, or a combination thereof. For example, the environmental condition sensor engine 120 may include a dedicated processor and storage. However, in some embodiments, the environmental condition sensor engine 120 may share hardware resources, including the processor 111 and storage 112 of the geolocating system 110 via, e.g., a bus 113.

In some embodiments, the environmental condition sensor engine 120 may retrieve environmental condition sensor data from the environmental sensor device(s) 150 via the remote device interface 116. In some embodiments, the environmental sensor device(s) 150 may include a sensor configured to measure at least one aspect of the environment at the location of the environmental sensor device(s) 150. In some embodiments, the aspect(s) may include, e.g., temperature, air pressure, humidity, light intensity, sunrise and/or sunset time, ultra-violet (UV) index, air quality, among other environmental conditions or any combination thereof. Accordingly, the environmental sensor device(s) 150 may include one or more environmental sensors such as, e.g., a thermometer, light intensity sensor (e.g., charge couple device (CCD) or other intensity sensor), UV light intensity sensor, barometer, hygrometer/humidity sensor, or any other suitable sensor or any combination thereof.

In some embodiments, the environmental condition sensor engine 120 may use the remote device interface 116 to obtain the environmental condition sensor data using a suitable messaging protocol, e.g., as detailed above. Thus, in response to control by the environmental condition sensor engine 120, the remote device interface 116 may query, request, poll, or otherwise communicate with the environmental sensor device(s) 150. In some embodiments, the communication may be continuous or periodic. In some embodiments, a periodic communication may include communications at a regular interval, such as e.g., hourly, daily, every two days, every three days, every four days, every five days, every six days, weekly, monthly, quarterly, biannually, annually, or by any other suitable interval. In some embodiments, more frequent environmental condition sensor data may facilitate faster and more accurate geolocating, while less frequency environmental condition sensor data may facilitate more efficient use of network and/or processing and/or memory resources. Thus, the interval may be configured to be a balance between speed/accuracy and efficiency, such as, e.g., daily, weekly, or other suitable interval. In some embodiments, the interval may be automatically determined, preconfigured, manually adjusted, or by any other suitable configuration. In some embodiments, the interval may be selected to match or exceed an interval at which the regional environmental condition data is obtained.

In some embodiments, the environmental sensor device(s) 150 may be associated with a particular home, commercial property, user, Internet-of-things device, computing device, home appliance, commercial appliance, among other devices or any combination thereof. Accordingly, in some embodiments, the environmental sensor device(s) 150 may collect measurements including values representative of one or more environmental conditions in the vicinity of the device(s). In some embodiments, the device(s) may not have a geolocation specified for the device(s). However, many device(s) and/or control/operation thereof may benefit from insight into the geolocation at which the device(s) is situated. Thus, the environmental sensor device(s) 150 collect a continuous and/or periodic time-series of measurement values representative of the environmental condition in the vicinity of the device(s) in order to enable environmental condition-based geolocation upon providing the time-series of measurement values to the environmental condition sensor engine 120.

In some embodiments, the environmental condition sensor engine 120 may pre-process the environmental condition sensor data. In some embodiments, the environmental condition sensor data may include measurements of the environment condition at the location of the environmental condition sensor data. In some embodiments, the measurements may be structured by the environmental condition sensor device 150 before uploading to the geolocating system 110. In some embodiments, the environmental condition sensor engine 120 may structure raw sensor measurements, such as, e.g., missing data imputation, noise reduction, and data normalization.

In some embodiments, missing data imputation may be employed to infer data points in the raw sensor data that are missing. Sometimes due to a sensor malfunction, unstable network 101 connection or other technical difficulties the data for some points in time may be missing. The missing data may be imputed via simple methods, such as, e.g., median imputation, mode imputation, mean imputation, random imputation among others or any combination thereof. The simple methods are fast and efficient but lack accuracy. In some embodiments, time-series specific methods may include, e.g., last observation carried forward (LOCF), next observation carried backward (NOCB), interpolation (linear, polynomial, Stineman, etc.), moving average (simple, weighted, exponential, etc.), among others or any combination thereof. In some embodiments, the time-series specific methods may be fast and work in specific cases but may fail to account for seasonality and/or large missing sub-sequences. In some embodiments, more sophisticated missing data imputation techniques may be employed, such as, e.g., Structural Model and Kalman Smoothing, ARIMA State Space Representation and Kalman Smoothing. Such techniques may account for seasonal data and/or other forms of complex patterns in the environmental condition sensor data.

In some embodiments, the environmental condition sensor data may have gaps of missing data can be too long for the aforementioned techniques to accurately impute missing data. Accordingly, in some embodiments, missing data imputation may be performed with Dynamic Time Warping, which may identify the most similar sub-sequence to the sub-sequence before the missing data, then complete the gap by the next sub-sequence of the most similar one. Dynamic Time Warping may impute plausible data in the gap at the expense of greater computational cost than the simpler techniques detailed above.

In some embodiments, noise reduction may be employed to address noise that obfuscates the actual data pattern. Accordingly, the noise reduction may subtract the maximum amount of noise from the initial data, leaving the maximum amount of useful signal. Thus, noise reduction may include one or more frequency domain and/or time domain approaches. In some embodiments, frequency domain approaches may include signal decomposition into frequency components, such as, e.g., discrete/fast/short-time Fourier transform either wavelet transform. In some embodiments, the time domain approaches may include, e.g., smoothing the signal of each given data point based on the values of its neighbors. Accordingly, in some embodiments, the noise reduction may employ, e.g., moving average filter, exponential smoothing filter, linear Fourier smoothing, nonlinear wavelet shrinkage and simple nonlinear noise reduction in different conditions, among others or any combination thereof.

In some embodiments, to address larger outlier errors, such as constraint-based approach that monitors the changes of values in time based on subject area constraints. Alternatively, for addressing smaller outliers, a statistical-based approach may be employed that use repairment likelihoods with respect to speed changes and/or heuristics.

In some embodiments, data normalization may be employed to ensure data uniformity across multiple sensor devices and/or with the regional environmental condition data from the external regional environmental condition data sources 160. Accordingly, one or more data normalization techniques, such as, e.g., min-max normalization, decimal scaling normalization, sigmoid normalization and/or z-score normalization may be employed, among others or any combination thereof.

In some embodiments, upon pre-processing the environmental condition sensor data, the environmental condition sensor engine 120 may formulate environmental condition sensor features from the environmental condition sensor data. In some embodiments, the environmental condition sensor features may include one or more statistical features, spectral features, timestamp features, among others or any combination thereof.

In some embodiments, statistical features may include, e.g., a sliding and/or rolling time window that moves through a time series of the environmental condition sensor data, and calculating statistics for each location (e.g., according to a defined width, interval, or other parameter or any combination thereof). In some embodiments, the statistics may include, e.g., the mean of the data within the window, the median of the data within the window, the mode of the data within the window, the minimal value of the data within the window, the maximum value of the data within the window, the standard deviation of the data within the window among other statistical features or any combination thereof.

In some embodiments, spectral features may include, e.g., Fourier transform and/or wavelet transform to decompose the environmental condition sensor data into a sum of basic functions, providing one or more representations of the initial signal.

In some embodiments, the timestamp features may include, e.g., features related to the time at which each value of the environmental condition sensor data was measured. Examples of timestamp features may include, e.g., hour of the day, time of the day, day of the week, day of the month, season of the year, among others or any combination thereof.

In some embodiments, to process the environmental condition sensor data, the geolocating system 110 may include computer engines including, e.g., an external environmental measurement engine 130. In some embodiments, the external environmental measurement engine 130 may include dedicated and/or shared software components, hardware components, or a combination thereof. For example, the external environmental measurement engine 130 may include a dedicated processor and storage. However, in some embodiments, the external environmental measurement engine 130 may share hardware resources, including the processor 111 and storage 112 of the geolocating system 110 via, e.g., a bus 113.

In some embodiments, the external environmental measurement engine 130 may use the remote device interface 116 to obtain the regional environmental data using a suitable messaging protocol, e.g., as detailed above. Thus, in response to control by the external environmental measurement engine 130, the remote device interface 116 may query, request, poll, or otherwise communicate with the external regional environmental condition data source(s) 160. In some embodiments, the communication may be continuous or periodic. In some embodiments, a periodic communication may include communications at a regular interval, such as e.g., hourly, daily, every two days, every three days, every four days, every five days, every six days, weekly, monthly, quarterly, biannually, annually, or by any other suitable interval. In some embodiments, more frequent regional environmental data may facilitate faster and more accurate geolocating, while less frequency regional environmental data may facilitate more efficient use of network and/or processing and/or memory resources. Thus, the interval may be configured to be a balance between speed/accuracy and efficiency, such as, e.g., daily, weekly, or other suitable interval. In some embodiments, the interval may be automatically determined, preconfigured, manually adjusted, or by any other suitable configuration. In some embodiments, the interval may be selected to match an interval at which the regional environmental condition data is published by the associated external regional environmental condition data source(s) 160.

In some embodiments, the external environmental measurement engine 130 may pre-process the regional environmental data. In some embodiments, the regional environmental data may include measurements of the environment condition at locations across a region. In some embodiments, the region may include any suitable geographic region and/or political region, such as, e.g., one or more continents, one or more countries, one or more states, one or more territories, one or more oceans, one or more landmasses, among other regions or any combination thereof.

In some embodiments, the external regional environmental condition data source(s) 160 may include one or more measurement ecosystems and/or services that operate across the region(s). For example, the external regional environmental condition data source(s) 160 may include, e.g., one or more public and/or private meteorological services, ground station measurement network(s), satellite monitoring system(s), forecasting system(s), among others or any combination thereof. Examples of such ecosystem(s) and/or service(s) may include, e.g., the National Oceanic and Atmospheric Administration (NOAA), the National Aeronautics and Space Administration (NASA), the National Weather Service (NWS), World Meteorological Organization (WMO) and/or any one or more members thereof, or any other suitable system and/or service that provides environmental condition measurement data across the region.

Thus, the external regional environmental condition data source(s) 160 collect and publish or otherwise make available a continuous and/or periodic time-series of measurement values representative of the environmental condition in the vicinity of the device(s) in order to enable environmental condition-based geolocation upon providing the time-series of measurement values to the external environmental measurement engine 130.

In some embodiments, the measurements may be structured by the external regional environmental condition data source(s) 160 before uploading to the geolocating system 110. In some embodiments, the external environmental measurement engine 130 may structure raw sensor measurements, such as, e.g., missing data imputation, noise reduction, and data normalization.

In some embodiments, missing data imputation may be employed to infer data points in the raw sensor data that are missing. Sometimes due to a sensor malfunction, unstable network 101 connection or other technical difficulties the data for some points in time may be missing. The missing data may be imputed via simple methods, such as, e.g., median imputation, mode imputation, mean imputation, random imputation among others or any combination thereof. The simple methods are fast and efficient but lack accuracy. In some embodiments, time-series specific methods may include, e.g., last observation carried forward (LOCF), next observation carried backward (NOCB), interpolation (linear, polynomial, Stineman, etc.), moving average (simple, weighted, exponential, etc.), among others or any combination thereof. In some embodiments, the time-series specific methods may be fast and work in specific cases but may fail to account for seasonality and/or large missing sub-sequences. In some embodiments, more sophisticated missing data imputation techniques may be employed, such as, e.g., Structural Model and Kalman Smoothing, ARIMA State Space Representation and Kalman Smoothing. Such techniques may account for seasonal data and/or other forms of complex patterns in the regional environmental data.

In some embodiments, the regional environmental data may have gaps of missing data can be too long for the aforementioned techniques to accurately impute missing data. Accordingly, in some embodiments, missing data imputation may be performed with Dynamic Time Warping, which may identify the most similar sub-sequence to the sub-sequence before the missing data, then complete the gap by the next sub-sequence of the most similar one. Dynamic Time Warping may impute plausible data in the gap at the expense of greater computational cost than the simpler techniques detailed above.

In some embodiments, noise reduction may be employed to address noise that obfuscates the actual data pattern. Accordingly, the noise reduction may subtract the maximum amount of noise from the initial data, leaving the maximum amount of useful signal. Thus, noise reduction may include one or more frequency domain and/or time domain approaches. In some embodiments, frequency domain approaches may include signal decomposition into frequency components, such as, e.g., discrete/fast/short-time Fourier transform either wavelet transform. In some embodiments, the time domain approaches may include, e.g., smoothing the signal of each given data point based on the values of its neighbors. Accordingly, in some embodiments, the noise reduction may employ, e.g., moving average filter, exponential smoothing filter, linear Fourier smoothing, nonlinear wavelet shrinkage and simple nonlinear noise reduction in different conditions, among others or any combination thereof.

In some embodiments, to address larger outlier errors, such as constraint-based approach that monitors the changes of values in time based on subject area constraints. Alternatively, for addressing smaller outliers, a statistical-based approach may be employed that use repairment likelihoods with respect to speed changes and/or heuristics.

In some embodiments, data normalization may be employed to ensure data uniformity across multiple sensor devices and/or with the regional environmental condition data from the external regional environmental condition data sources 160. Accordingly, one or more data normalization techniques, such as, e.g., min-max normalization, decimal scaling normalization, sigmoid normalization and/or z-score normalization may be employed, among others or any combination thereof.

In some embodiments, upon pre-processing the regional environmental data, the external environmental measurement engine 130 may formulate regional environmental condition features from the regional environmental data. In some embodiments, the regional environmental condition features may include one or more statistical features, spectral features, timestamp features, among others or any combination thereof.

In some embodiments, statistical features may include, e.g., a sliding and/or rolling time window that moves through a time series of the regional environmental data, and calculating statistics for each location (e.g., according to a defined width, interval, or other parameter or any combination thereof). In some embodiments, the statistics may include, e.g., the mean of the data within the window, the median of the data within the window, the mode of the data within the window, the minimal value of the data within the window, the maximum value of the data within the window, the standard deviation of the data within the window among other statistical features or any combination thereof.

In some embodiments, spectral features may include, e.g., Fourier transform and/or wavelet transform to decompose the regional environmental data into a sum of basic functions, providing one or more representations of the initial signal.

In some embodiments, the timestamp features may include, e.g., features related to the time at which each value of the regional environmental data was measured. Examples of timestamp features may include, e.g., hour of the day, time of the day, day of the week, day of the month, season of the year, among others or any combination thereof.

In some embodiments, to process the environmental condition sensor data, the geolocating system 110 may include computer engines including, e.g., a geolocating engine 140. In some embodiments, the geolocating engine 140 may include dedicated and/or shared software components, hardware components, or a combination thereof. For example, the geolocating engine 140 may include a dedicated processor and storage. However, in some embodiments, the geolocating engine 140 may share hardware resources, including the processor 111 and storage 112 of the geolocating system 110 via, e.g., a bus 113.

In some embodiments, the geolocation engine 140 may ingest the environmental condition sensor features and the regional environmental condition features to determine a geolocation associated with the environmental condition sensor device(s) 150. Both the environmental condition sensor features, and the regional environmental condition features capture characteristics of environmental condition measurements at one or more times. In some embodiments, based on the values of the environmental condition sensor features and a time-dependent map of the regional environmental condition features, the environmental condition sensor features and the regional environmental condition features may be aligned to locate the environmental condition sensor device(s) 150 within the region based on matching the patterns through time of the measurement values the environmental condition sensor features and the regional environmental condition features.

For example, in some embodiments, the variation of the environmental condition sensor features through time may be used to produce an environmental condition sensor signature. The signature represents the variation and/or time-dependent patterns of measurements of the environment at the location of the environmental condition sensor device(s) 150 through time.

Similarly, the variation of the regional environmental condition features through time may be used to produce a regional environmental condition signature at one or more locations within the region. The signature represents the variation and/or time-dependent patterns of regional measurements of the environment across the region.

In some embodiments, the environmental condition sensor signature may be matched to the regional environmental condition signature at a particular location based on commonalities in how the environmental conditions vary through time according to the environmental condition sensor features and the regional environmental condition features. In some embodiments, the geolocation engine 140 may employ a data model to reliably and efficiently match the environmental condition sensor signature to a regional environmental condition signature at a particular location.

In some embodiments, the data model may include, e.g., an iterative refinement technique using a time-varying series of the environmental condition sensor features and the regional environmental condition features. For example, in a first iteration, all locations in the region having regional environmental condition features within a threshold similarity measure of the environmental condition sensor features at the same time may be identified as candidate locations. In some embodiments, the similarity measure may be a different between the value(s) of environmental condition sensor features and the regional environmental condition features, a magnitude of a difference between environmental condition sensor features and the regional environmental condition features, a Jaccard similarity between environmental condition sensor features and the regional environmental condition features, Jaro-Winkler similarity between environmental condition sensor features and the regional environmental condition features, Cosine similarity between environmental condition sensor features and the regional environmental condition features, Euclidean similarity between environmental condition sensor features and the regional environmental condition features, Overlap similarity between environmental condition sensor features and the regional environmental condition features, Pearson similarity between environmental condition sensor features and the regional environmental condition features. Approximate Nearest Neighbors between environmental condition sensor features and the regional environmental condition features, K-Nearest Neighbors between the environmental condition sensor features and the regional environmental condition features, among other similarity measures or any combination thereof.

In some embodiments, similarity may be measured between each individual feature separately, and the respective similarity scores summed, averaged, or otherwise combined to produce a measure of similarity of the environmental condition sensor features and the regional environmental condition features. In some embodiments, the similarity may instead or in addition be measured for a combination of features. For example, a hash or group key may be generated combining the environmental condition sensor features and for the regional environmental condition features. The hash may include a hash functioning take as input each of feature or a subset of features of the environmental condition sensor features and the regional environmental condition features. The group key may be produced by creating a single string, list, or value from combining each of, e.g., a string, list or value representing each individual feature of the environmental condition sensor features and the regional environmental condition features. The similarity between the environmental condition sensor features and the regional environmental condition features may then be measured as the similarity between the associated hashes and/or group keys. The measured similarity may then be compared against the predetermined similarity score to determine candidate locations.

In some embodiments, the similarity measure may be assessed using a suitable clustering model. For example, the clustering model may include, e.g., K-means clustering algorithm, DBSCAN clustering algorithm, Gaussian Mixture Model algorithm, Balance Iterative Reducing and Clustering using Hierarchies (BIRCH) algorithm, Affinity Propagation clustering algorithm, Mean-Shift clustering algorithm, Ordering Points to Identify the Clustering Structure (OPTICS) algorithm. Agglomerative Hierarchy clustering algorithm, among others or any combination thereof.

In some embodiments, the candidate locations may be identified based on a threshold similarity measure. In some embodiments, the threshold similarity measure may include, e.g., a percent difference (e.g., 1%, 2%, 3%, 4%, 5%, 6% or more, or any suitable percent difference in a range of 0.1 to 10.0% or other suitable threshold or any combination thereof), fraction, absolute difference, standard deviation, among other suitable thresholding approaches or any combination thereof.

In some embodiments, at a next iteration, the same similarity process may be conducted with a next set of the environmental condition sensor features and the regional environmental condition features at a next time. In some embodiments, the next iteration may restrict the regional environmental condition features to just the candidate locations. Accordingly, assessing similarity between the environmental condition sensor features and the regional environmental condition features for candidate locations may identify a smaller set of candidate locations within the candidate location that are similar to the environmental condition sensor features at both the first iteration and next iteration, thus refining the candidate locations. In some embodiments, the process may be repeated any number of iterations until a particular location associated with the environmental condition sensor device(s) 150 is pinpointed.

In some embodiments, the data model may additionally or alternatively include one or more machine learning models configured to match the environmental condition sensor features and the regional environmental condition features. For example, the machine learning model(s) may classify the time-varying environmental condition sensor features as a signal matching to a particular regional environmental condition feature signal for measured at a particular location. In some embodiments, the machine learning model(s) may include one or more exemplary AI/machine learning techniques chosen from, but not limited to, decision trees, boosting, support-vector machines, neural networks, nearest neighbor algorithms, Naive Bayes, bagging, random forests, and the like. In some embodiments and, optionally, in combination of any embodiment described above or below, an exemplary neutral network technique may be one of, without limitation, feedforward neural network, radial basis function network, recurrent neural network, convolutional network (e.g., U-net) or other suitable network. In some embodiments and, optionally, in combination of any embodiment described above or below, an exemplary implementation of Neural Network may be executed as follows:
a. define Neural Network architecture/model,
b. transfer the input data to the exemplary neural network model,
c. train the exemplary model incrementally,
d. determine the accuracy for a specific number of timesteps,
e. apply the exemplary trained model to process the newly-received input data,
f. optionally and in parallel, continue to train the exemplary trained model with a predetermined periodicity.

In some embodiments and, optionally, in combination of any embodiment described above or below, the exemplary trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the exemplary trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the exemplary aggregation function may be a mathematical function that combines (e.g., sum, product, etc.) input signals to the node. In some embodiments and, optionally, in combination of any embodiment described above or below, an output of the exemplary aggregation function may be used as input to the exemplary activation function. In some embodiments and, optionally, in combination of any embodiment described above or below, the bias may be a constant value or function that may be used by the aggregation function and/or the activation function to make the node more or less likely to be activated.

In some embodiments, upon identifying the matching location, the geolocation engine 140 may access a device profile associated with the environmental condition sensor device(s) 150. In some embodiments, the device profile may be stored in the storage 112. Accordingly, the geolocation engine 140 may generate a query identifying the environmental condition sensor device(s) 150, such as, e.g., using a device identifier, profile identifier, user identifier of an associated user, device identifier of an associated IoT device, among other device profile identifying information or any combination thereof.

In some embodiments, in response to the query the storage 112 may access a device profile database 114 storing the device profiles of all environmental condition sensor device(s) 150 and return the device profile of the queried environmental condition sensor device(s) 150. Accordingly, the geolocation engine 140 may then, or as part of the query itself, command the storage 112 to modify the device profile in the device profile database 114 to specify the matching location. In some embodiments, in an iterative refining process, e.g., as detailed above, at each iteration, the device profile may be modified with the latest refinement to the candidate locations. Accordingly, the device profile may be more accurately associated with a particular geolocation as time passes without the use of manual input of the geolocation or GPS or other positioning systems, including, e.g., cellular and/or WiFi triangulation, etc.

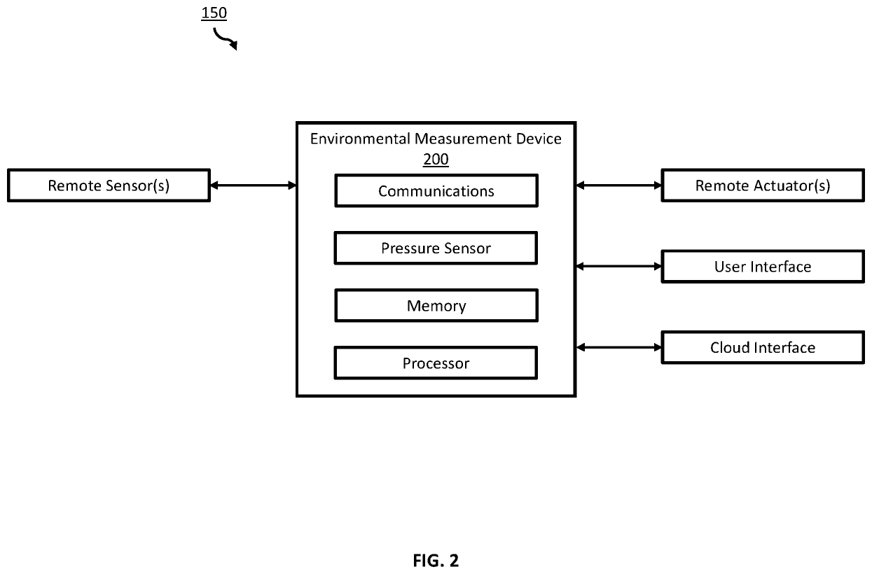

FIG. 2 illustrates an example environmental measurement device for environmental measurement-based geolocation determination in accordance with one or more embodiments of the present disclosure.

In some embodiments, an environmental measurement sensor device 150 may include an environmental measurement device 200 configured to perform the measurement of the environmental condition(s) and obtain one or more measurement values. In some embodiments, the environmental condition may include air and/or atmospheric pressure. Accordingly, the environmental measurement device 200 may include a pressure sensor, such as, e.g., a micro-pressure sensor.

In some embodiments, the environmental measurement device 200 may control the pressure sensor to collect pressure measurements using computational resource such as, e.g., a processor, a memory, among others or any combination thereof. Accordingly, the processor may instruct the pressure sensor to collect a measurement, and the measurement may be stored in the memory for later access and/or communication to the geolocating system 110.

In some embodiments, the environmental measurement device 200 may include a communications unit for communicating with other systems and/or devices, e.g., over one or more networks and/or via direct wired/wireless connection. In some embodiments, the communication unit may communicate the measurements from the pressure sensor to the geolocating system 110 via a cloud interface (e.g., the remote device interface 116 as detailed above). In some embodiments, the communication unit may return the measurements to the geolocating system 110 in response to a request or query for the measurement, or the communication unit may publish the measurement for receiving by a subscribing device and/or system such as the geolocating system. Any other suitable messaging paradigm may be employed or any combination thereof.

In some embodiments, the communication unit may interface with remote sensor(s) and/or remote actuator(s) of an IoT device. For example, the environmental measurement device 200 may be associated with, e.g., a smart thermostat, IoT hub, smart appliance, or other IoT device. The IoT device may include one or more remote sensor(s) for collecting data used in control of the remote actuator(s) of the IoT device. The remote sensor(s) may include, e.g., a thermometer, a strain sensor, a moisture sensor, a light intensity sensor, a smoke detector, a timer, a digital camera, among other sensors or any combination thereof. The remote actuator(s) may include, e.g., a heating element, a linear and/or rotational mechanical actuator, a pump, a light, among others or any combination thereof.

In some embodiments, the environmental measurement device 200 may output information to a user interface, e.g., on a display of the environmental measurement sensor device 150 and/or an associated computing device. In some embodiments, the user interface may include interface elements to present, e.g., environmental condition measurements, remote sensor(s) status, remote actuator(s) status, user input field(s) for, e.g., configuring the environmental measurement sensor device 150, establishing set points, turning on or off the environmental measurement sensor device 150, among other user input functions, among other interface elements or any combination thereof.

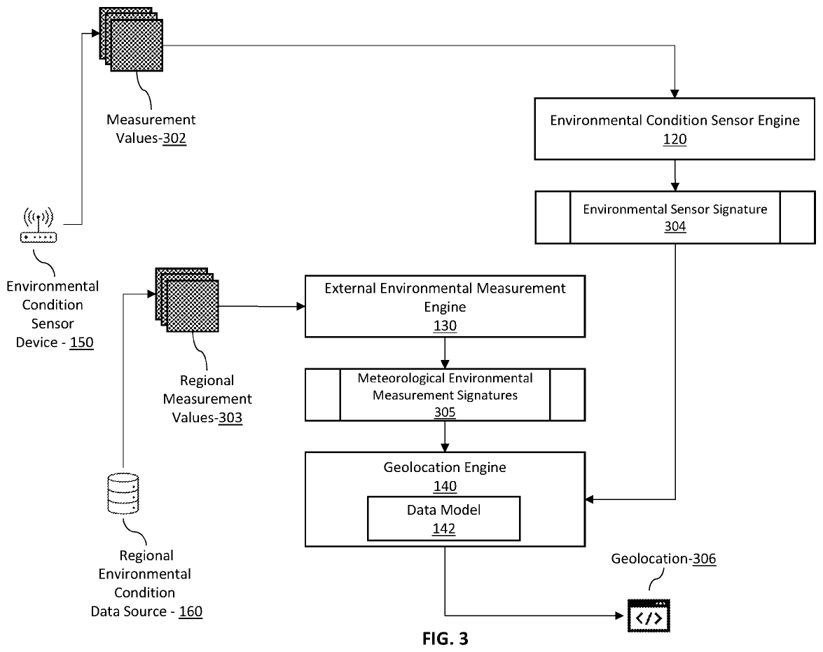

FIG. 3 illustrates environmental measurement-based geolocation determination using the computer-based geolocating system in accordance with one or more embodiments of the present disclosure.

In some embodiments, the environmental condition sensor engine 120 may receive environmental sensor data from at least one environmental sensor associated with at least one Internet-of-Things (IoT) device. In some embodiments, the environmental sensor data may include one or more environmental sensor measurements of at least one environmental condition of a local environment at a device location associated with the IoT device associated with an environmental condition sensor device 150 over a period time. For example, the environmental sensor measurement(s) may include a series of measurement values 302 through time as an input stream to the environmental condition sensor engine 120.

In some embodiments, the at least one environmental condition may include one or more suitable environmental condition measurements, such as, e.g., pressure, humidity, temperature, ultra-violet index, air quality, among others or any combination thereof.

In some embodiments, the environmental condition sensor engine 120 may generate an environmental sensor signature 304 representing a variation of at least one characteristic of the environmental sensor data over the period of time. In some embodiments, to generate the environmental sensor signature 304, the environmental condition sensor engine 120 may pre-process the measurement values 302 and perform feature engineering to identify features indicative of the characteristic(s) through time. The time-varying features may form the environmental sensor signature 304 that represents a specific pattern of environmental condition variation at the location of the IoT device.

In some embodiments, the external environmental measurement engine 130 may access regional environmental data from a regional environmental condition data source 160, such as, e.g., meteorological environmental measurements values 303 of at least one meteorological condition across geographic locations over the period time.

In some embodiments, the environmental data may include meteorological environmental measurement values 303 collected by atmospheric, aeronautic, ground station and/or satellite measurement systems for, e.g., pressure, humidity, temperature, ultra-violet index, air quality, among others or any combination thereof.

In some embodiments, the external environmental measurement engine 130 may generate a meteorological environmental measurement signature 305 representing a variation of at least one characteristic of the regional measurement values 303 over the period of time. In some embodiments, to generate the meteorological environmental measurement signature 305, the external environmental measurement engine 130 may pre-process the measurement values 302 and perform feature engineering to identify features indicative of the characteristic(s) through time. The time-varying features may form the meteorological environmental measurement signature 305 that represents a specific pattern of environmental condition variation at one or more locations in the region.

In some embodiments, the features of the meteorological environmental measurement may be affected by one or more measurement-affecting geographic features associated with each geographic location, such as, e.g., elevation affecting temperature, humidity and/or pressure, man-made structures, concrete and/or asphalt surfacing affecting temperature and/or wind speed, tree cover affecting temperature, among others or any combination thereof.

In some embodiments, the external environmental measurement engine 130 determine for each geographic location, a location-adjusted meteorological environmental measurement based at least in part on a compensation for the measurement-affecting geographic feature in order to form a meteorological environmental measurement signature 305 for each location that is comparable to the environmental sensor signature 304.

In some embodiments, the geolocation engine 140 may ingest the meteorological environmental measurement signatures 305 of the locations in the region and the environmental sensor signature 304 for the location of the IoT device. In some embodiments, the geolocation engine 140 may instantiate a data model 142 to search the meteorological environmental measurement signatures 305 for environmental conditions matching the environmental sensor signature 304. In some embodiments, the data model may include, e.g., an iterative similarity analysis that iteratively narrows a set of candidate locations based on the similarity through time with the environmental sensor signature 304. In some embodiments, the geolocation engine 140 may first ingest the meteorological environmental measurement signatures 305 of the locations in the region and the environmental sensor signature 304 for the location of the IoT device for a sequence of times to form a time-dependent signature for each location, and match the time-dependent signatures to identify a matching meteorological environmental measurement signature 305, e.g., using the data model including a machine learning model, heuristic search, clustering, among other techniques or any combination thereof.

In some embodiments, to ensure that the meteorological environmental measurement signatures 305 and the environmental sensor signature 304 are for comparable time periods, the data model may include, e.g., an alignment algorithm such as, e.g., Dynamic Time Warping.

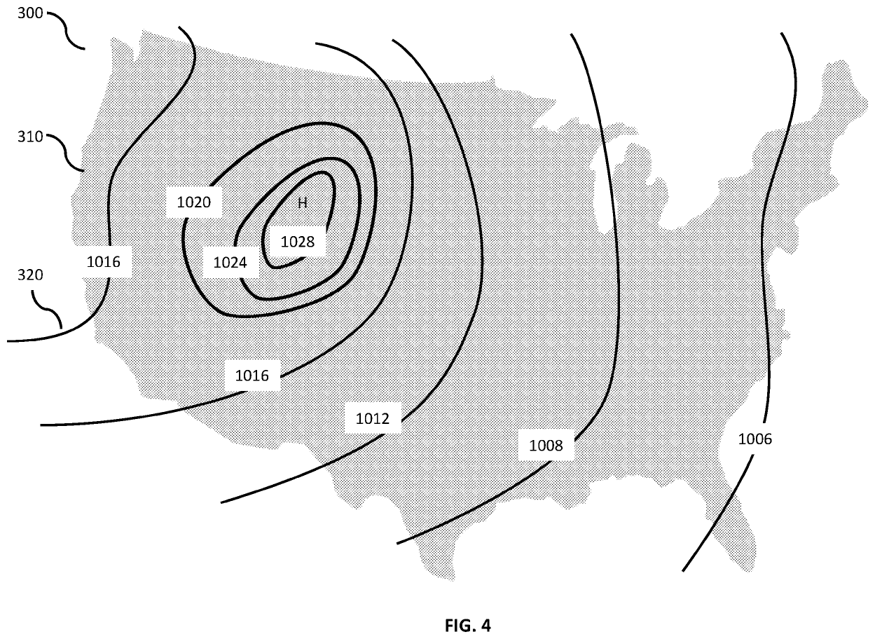

FIG. 4 is a diagram illustrating a map of a geographic region including the contiguous 48 states of the United States of America (“the US”) over laid with Isobar lines indicating pressures across the geographic region at a first time in accordance with one or more embodiments of the present disclosure.

FIG. 4 shows a weather map 300 for the continental 48 contiguous United States 310 over laid with atmospheric Isobar lines 320 (pressure in millibars reduced to sea level). Isobar lines 320 are a form of weather reporting that show lines of constant pressure which indicate average atmospheric pressure, reduced to sea level, for a specific time. By looking at the same representation at a later time, the Isobar lines 320 show how the atmospheric pressure is changing. These changes provide weather insights and are useful in forecasting coming weather characteristics. Controllers, for example a thermostat or HVAC system controller can benefit from these same insights as this information may be used to forecast an increase or decrease in heating or cooling demand for example.

In some embodiments, estimating the geolocation of a controller may include incorporating a pressure sensor in the controller and to compare the pressure reading from this to weather atmospheric data available through a cloud data connection. Here surface pressure weather data may be compared to the controller's pressure sensor data to determine the geographic regions where the two pressures are within a range of each other. For example, if the controller's pressure reading is within, e.g., +/−1%, 2%, 3%, 4%, 5% or other deviation threshold or any combination thereof, of the atmospheric surface pressure in a region, then that region may be considered a candidate location for the controller. Successive collections of data, performing the comparison, determining the threshold region, and logically combining the regions or layers, may refine the candidate locations. Indeed, the surface pressure changing with the location of the controller being constant enables cross referencing a signature of the pressure sensor reading at the controller with a signature of the Isobar lines to identify the true location.

In some embodiments, a simple example may include that the region in consideration is flat and at sea level. FIG. 4, shows the region of the continental US over laid with exemplary Isobar lines. These lines show lines of constant pressure which indicate average atmospheric pressure, reduced to sea level, for a specific time.

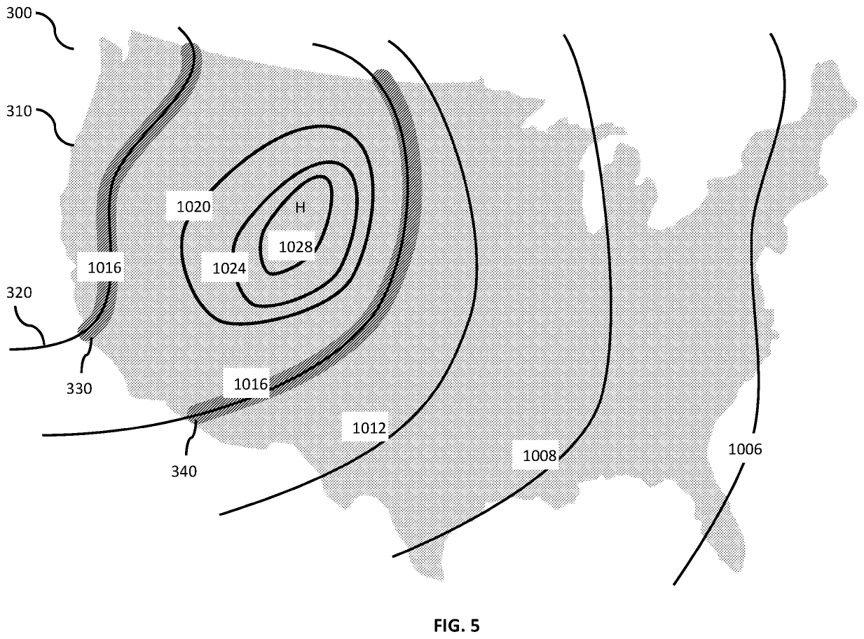

FIG. 5 is a diagram illustrating a map of a geographic region including the contiguous 48 states of the United States of America (“the US”) over laid with Isobar lines indicating pressures across the geographic region and highlighting matching Isobar lines at the first time in accordance with one or more embodiments of the present disclosure.

In some embodiments, the pressure sensor in the controller reads the pressure of the controller's location to be 1016 millibars. Thresholding the cloud weather data for 1016+/−2% yields regions in the continental US where the 1016 millibar controller reading is in correlation with the weather data. This region 330, 340 is illustrated in FIG. 5, by a wider grey region shown under lying the 1016 millibar Isobar contours. From the single data point in this simplification and the threshold of current weather data it can be estimated that the controller is located somewhere along Isobar contours 1016 in regions 330, 340.

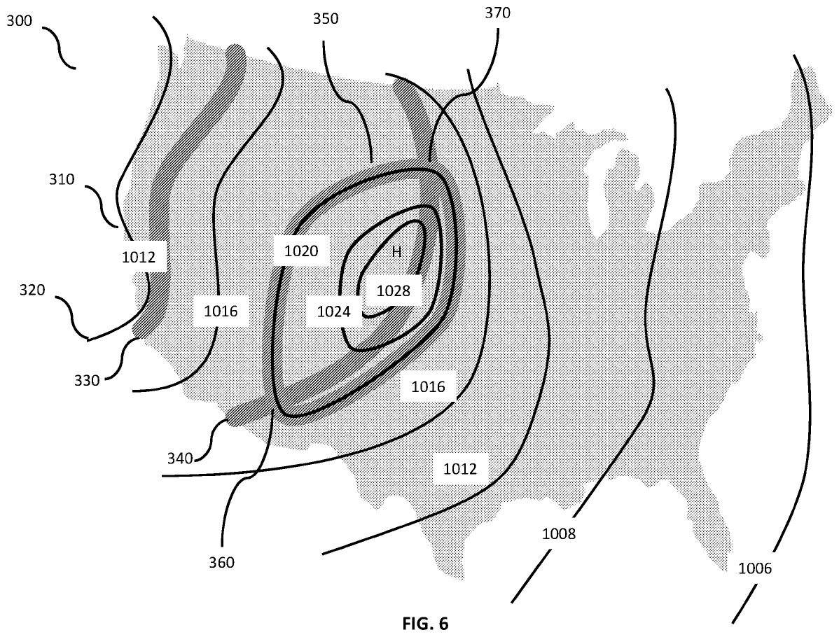

FIG. 6 is a diagram illustrating a map of a geographic region including the contiguous 48 states of the United States of America (“the US”) over laid with Isobar lines indicating pressures across the geographic region and highlighting matching Isobar lines at a second time in accordance with one or more embodiments of the present disclosure.

FIG. 6 shows similar data as FIG. 4 and FIG. 5, however at a later time, where the weather conditions and corresponding Isobar data has changed. In some embodiments, the pressure sensor may read, e.g., 1020 millibars. Since the controller has not moved, the previous threshold Isobar location correlation data region is still valid. Thresholding the cloud weather data at this later time and for the 1020 millibar pressure+/−2% at a current time may yield new regions in the continental US where the 1020 millibar reading is in correlation with the weather data. Logically overlaying the new region over the previously threshold region (logical AND), shows an intersection of the data regions in two locations 360, 370. Therefore, it may be determined that it is likely that the controller is located at one of the two locations where the logical AND of the two previous threshold processed regions test true 360, 370. Note that the previously threshold process had identified two regions 330 and 340 that were possible locations for the controller. From the second threshold region and the logical AND with this data, it may be evident that the first of these two regions 330 tests false and is not likely where the controller is located.

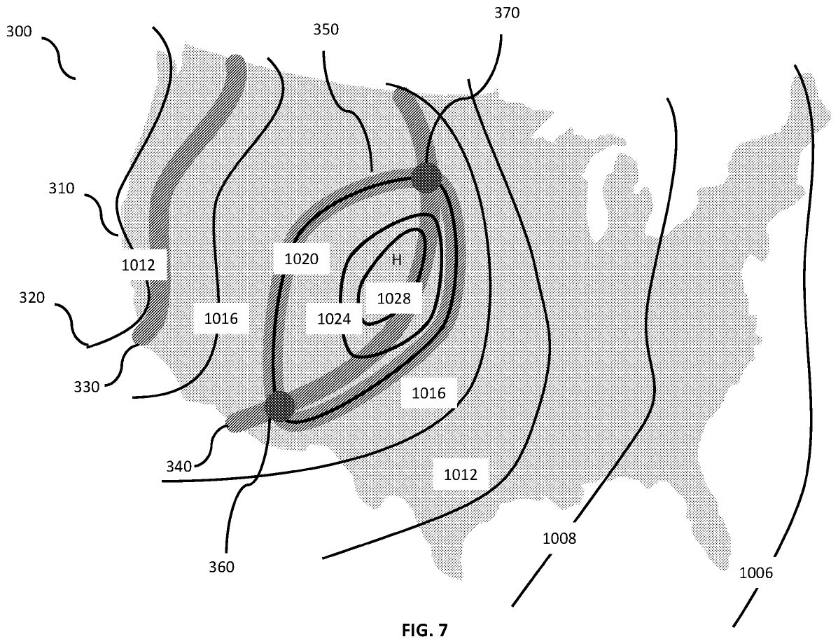

FIG. 7 is a diagram illustrating geolocation candidates at the second time based on the matching Isobar lines in the geographic region in accordance with one or more embodiments of the present disclosure. FIG. 7, further illustrates the results of the logical AND between the two first threshold processes by drawing a circle around the logical intersections of the first two data sets at 160, 170. It is now likely the controller is at one of the two locations.

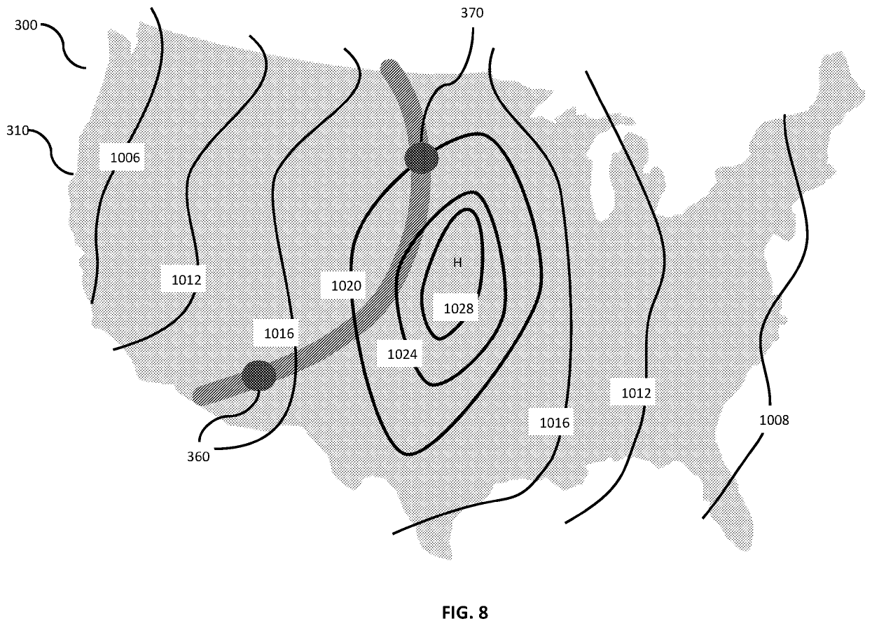

FIG. 8 is a diagram illustrating geolocation candidates at a third time based on the matching Isobar lines in the geographic region in accordance with one or more embodiments of the present disclosure. FIG. 8 shows similar data as FIG. 4, FIG. 5, and FIG. 6 however again at a later time, where the weather conditions and corresponding Isobar data has changed. In some embodiments, the pressure sensor may again read 1020 millibars at the current time. Since the controller has not moved, the previous threshold Isobar location correlation data region is still valid. Thresholding the cloud weather data at the current time for the 1020 millibar pressure+/−2%, yields new regions in the continental US where the 1020 millibar reading is in correlation with the weather data. Logically overlaying this new region over the previously threshold region (logical AND), shows an intersection of the data regions at location 370. It is now likely that the controller is located at the one location where the logical AND of the previous threshold processed regions test true 370.

In some embodiments, the example illustrated in FIGS. 4 through 8 may, in practice, use surface pressure data which differs from the Isobar data. Surface pressure data is equivalent to the Isobar data but is adjusted to the correct altitude for the surface location to yield surface pressure. In this case the Isobar data can be used and be geographically adjusted to the correct altitude and surface temperature at each location. The adjustment may be performed (e.g., by the external environmental measurement engine 130) with the following formula using location altitude and temperature data. P₀ in this case would be the pressure data from the Isobars, h the altitude for each location, and T the temperature for each location at the time of measurement.

$$P = {{P}_{0} ( 1 - \frac{0 \text{.0065} h}{T + 0.0065 h + 273.15} )}^{5.257}$$

where P is the pressure at a given altitude, P₀ is the pressure at sea level, h is the altitude in meters, and T is the air temperature in Celsius.

Alternatively, surface pressure data can be directly compared with the pressure measurements from the controller pressure sensor. Surface pressure data does not represent in clean lines of constant pressure like the Isobar lines. It is more fragmented, however the same techniques detailed above for thresholding the measured pressure data with the surface pressure data for a region, finding the regions where the controller's pressure is in the range of the surface pressures, and repeating this process over time, and logically AND these results, to refine the controller location, still applies.

In some embodiments, other methods for establishing the controller location using the integrated pressure sensor may be employed, such as, for example, instead of using the average surface pressure for a period of time for the comparison, the rate of surface pressure change for each possible location can be used to be compared to the rate of surface pressure change measured at the controller location. Additionally, surface pressure change characteristics over a period of time can be compared between weather data and the measured data.

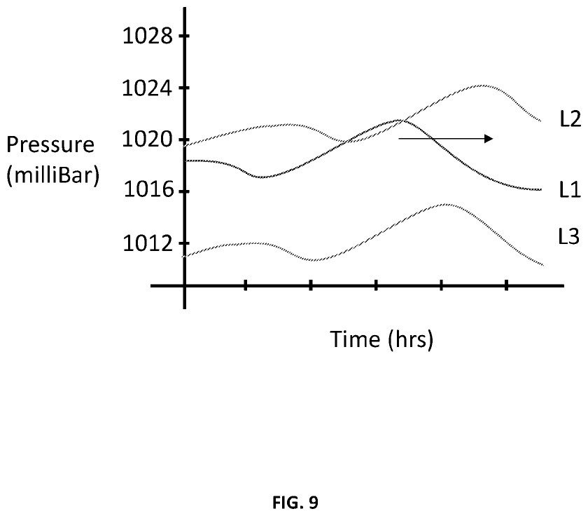

FIG. 9 is a graph showing atmospheric pressure changes at three locations L1, L2 and L3 in accordance with one or more embodiments of the present disclosure. Here the graph shows the pressure for location L1 over time. Similarly, the graph shows the pressure for a different location L2 also over time. It can be noted that L2 shows a similar pressure data signature, however, delayed by a predetermined amount of time (e.g., about 12 hour, 1 hour, 1-½ hours, 2 hours, etc.) in time. Applying the data analytics technique for miss aligned temporal series data, of Dynamic Time Warping, enables the data to be aligned and to extract the time delay between the data sets and in this case location differences. Dynamic time warping facilitates the processing of a large number of signals, to find similar signatures, that are offset in time. Once found, the similar signature locations are identified with their accompanying time offsets. This data can indicate if the unknown, but correlated, location is seeing pressure changes before or after the known location. The unknown location can also be triangulated between one or more known locations to estimate its location. For example, if the correlation occurs after one known location, and before a second known location, it can be inferred that the unknown location is between the two known locations. Further, the time offsets to these locations can allow the calculation of where in between these locations the unknown location is. Weather data may also include movement speed, such as the speed and direction that a pressure front has. For pressure correlations from an unknown location to a known location, where the time offset is provided by the time warping, and where the movement speed of the pressure signature is known, the direct calculation of the unknown location may be made. Using time warping correlations to more the one known location, where the movement speed of the pressure signature is known, further allows the unknown location to be determined. Since the location for one of the data sets is known (the weather data set), the other can be established (the controller location). A number of combinations of the methods described can be used to establish the location for the controller.

The principles described above can also be applied to geolocation withing a building or structure. For example, assume that there are two products located in a structure each containing a pressure sensor. Assume that the locations of the products are not known within the structure. The measurement of the absolute pressure from the pressure sensors provides data for the elevation of each sensor and its associated product. For example, from this measurement, it can be determined if the sensors are on the same floor or on different floors of the building or home. The technique of time warping described above can also be applied to determine the relative location of multiple sensors. Opening windows or doors, outside breezes produce time domain pressure signatures. Time warping and or intensity mapping of these signatures can show which sensors are closer to and or further away from these signature sources thus providing information to establish the relative locations of the sensors. As described above for refining the location, using successive logical AND or averaging of a relative location map with new location information, provides for the refinement of the location predictions.

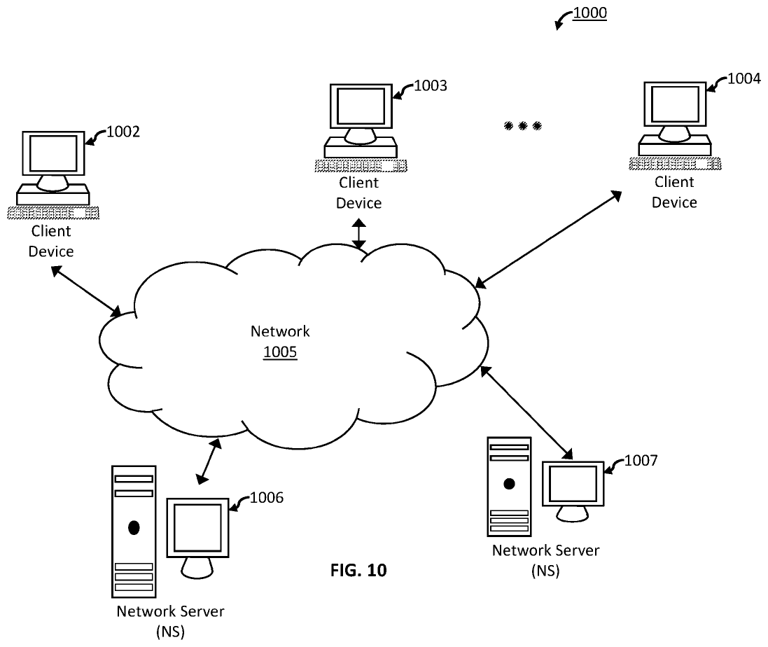

FIG. 10 depicts a block diagram of an exemplary computer-based system and platform 1000 for environmental measurement-based geolocation determination in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the illustrative computing devices and the illustrative computing components of the exemplary computer-based system and platform 1000 may be configured to manage a large number of members and concurrent transactions, as detailed herein. In some embodiments, the exemplary computer-based system and platform 1000 may be based on a scalable computer and network architecture that incorporates varies strategies for assessing the data, caching, searching, and/or database connection pooling. An example of the scalable architecture is an architecture that is capable of operating multiple servers.

In some embodiments, referring to FIG. 10, client device 1002, client device 1003 through client device 1004 (e.g., clients) of the exemplary computer-based system and platform 1000 may include virtually any computing device capable of receiving and sending a message over a network (e.g., cloud network), such as network 1005, to and from another computing device, such as servers 1006 and 1007, each other, and the like. In some embodiments, the client devices 1002 through 1004 may be personal computers, multiprocessor systems, microprocessor-based or programmable consumer electronics, network PCs, and the like. In some embodiments, one or more client devices within client devices 1002 through 1004 may include computing devices that typically connect using a wireless communications medium such as cell phones, smart phones, pagers, walkie talkies, radio frequency (RF) devices, infrared (IR) devices, citizens band radio, integrated devices combining one or more of the preceding devices, or virtually any mobile computing device, and the like. In some embodiments, one or more client devices within client devices 1002 through 1004 may be devices that are capable of connecting using a wired or wireless communication medium such as a PDA, POCKET PC, wearable computer, a laptop, tablet, desktop computer, a netbook, a video game device, a pager, a smart phone, an ultra-mobile personal computer (UMPC), and/or any other device that is equipped to communicate over a wired and/or wireless communication medium (e.g., NFC, RFID, NBIOT, 3G, 4G, 5G, GSM, GPRS, WiFi, WiMax, CDMA, OFDM, OFDMA, LTE, satellite, ZigBee, etc.). In some embodiments, one or more client devices within client devices 1002 through 1004 may include may run one or more applications, such as Internet browsers, mobile applications, voice calls, video games, videoconferencing, and email, among others. In some embodiments, one or more client devices within client devices 1002 through 1004 may be configured to receive and to send web pages, and the like. In some embodiments, an exemplary specifically programmed browser application of the present disclosure may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In some embodiments, a client device within client devices 1002 through 1004 may be specifically programmed by either Java, .Net, QT, C, C++, Python, PHP and/or other suitable programming language. In some embodiment of the device software, device control may be distributed between multiple standalone applications. In some embodiments, software components/applications can be updated and redeployed remotely as individual units or as a full software suite. In some embodiments, a client device may periodically report status or send alerts over text or email. In some embodiments, a client device may contain a data recorder which is remotely downloadable by the user using network protocols such as FTP, SSH, or other file transfer mechanisms. In some embodiments, a client device may provide several levels of user interface, for example, advance user, standard user. In some embodiments, one or more client devices within client devices 1002 through 1004 may be specifically programmed include or execute an application to perform a variety of possible tasks, such as, without limitation, messaging functionality, browsing, searching, playing, streaming or displaying various forms of content, including locally stored or uploaded messages, images and/or video, and/or games.

In some embodiments, the exemplary network 1005 may provide network access, data transport and/or other services to any computing device coupled to it. In some embodiments, the exemplary network 1005 may include and implement at least one specialized network architecture that may be based at least in part on one or more standards set by, for example, without limitation, Global System for Mobile communication (GSM) Association, the Internet Engineering Task Force (IETF), and the Worldwide Interoperability for Microwave Access (WiMAX) forum. In some embodiments, the exemplary network 1005 may implement one or more of a GSM architecture, a General Packet Radio Service (GPRS) architecture, a Universal Mobile Telecommunications System (UMTS) architecture, and an evolution of UMTS referred to as Long Term Evolution (LTE). In some embodiments, the exemplary network 1005 may include and implement, as an alternative or in conjunction with one or more of the above, a WiMAX architecture defined by the WiMAX forum. In some embodiments and, optionally, in combination of any embodiment described above or below, the exemplary network 1005 may also include, for instance, at least one of a local area network (LAN), a wide area network (WAN), the Internet, a virtual LAN (VLAN), an enterprise LAN, a layer 3 virtual private network (VPN), an enterprise IP network, or any combination thereof. In some embodiments and, optionally, in combination of any embodiment described above or below, at least one computer network communication over the exemplary network 1005 may be transmitted based at least in part on one of more communication modes such as but not limited to: NFC, RFID, Narrow Band Internet of Things (NBIOT), ZigBee, 3G, 4G, 5G, GSM, GPRS, WiFi, WiMax, CDMA, OFDM, OFDMA, LTE, satellite and any combination thereof. In some embodiments, the exemplary network 1005 may also include mass storage, such as network attached storage (NAS), a storage area network (SAN), a content delivery network (CDN) or other forms of computer or machine readable media.

In some embodiments, the exemplary server 1006 or the exemplary server 1007 may be a web server (or a series of servers) running a network operating system, examples of which may include but are not limited to Apache on Linux or Microsoft IIS (Internet Information Services). In some embodiments, the exemplary server 1006 or the exemplary server 1007 may be used for and/or provide cloud and/or network computing. Although not shown in FIG. 10, in some embodiments, the exemplary server 1006 or the exemplary server 1007 may have connections to external systems like email, SMS messaging, text messaging, ad content providers, etc. Any of the features of the exemplary server 1006 may be also implemented in the exemplary server 1007 and vice versa.

In some embodiments, one or more of the exemplary servers 1006 and 1007 may be specifically programmed to perform, in non-limiting example, as authentication servers, search servers, email servers, social networking services servers, Short Message Service (SMS) servers, Instant Messaging (IM) servers, Multimedia Messaging Service (MMS) servers, exchange servers, photo-sharing services servers, advertisement providing servers, financial/banking-related services servers, travel services servers, or any similarly suitable service-base servers for users of the client devices 1001 through 1004.

In some embodiments and, optionally, in combination of any embodiment described above or below, for example, one or more exemplary computing client devices 1002 through 1004, the exemplary server 1006, and/or the exemplary server 1007 may include a specifically programmed software module that may be configured to send, process, and receive information using a scripting language, a remote procedure call, an email, a tweet, Short Message Service (SMS), Multimedia Message Service (MMS), instant messaging (IM), an application programming interface, Simple Object Access Protocol (SOAP) methods, Common Object Request Broker Architecture (CORBA), HTTP (Hypertext Transfer Protocol), REST (Representational State Transfer), SOAP (Simple Object Transfer Protocol), MLLP (Minimum Lower Layer Protocol), or any combination thereof.

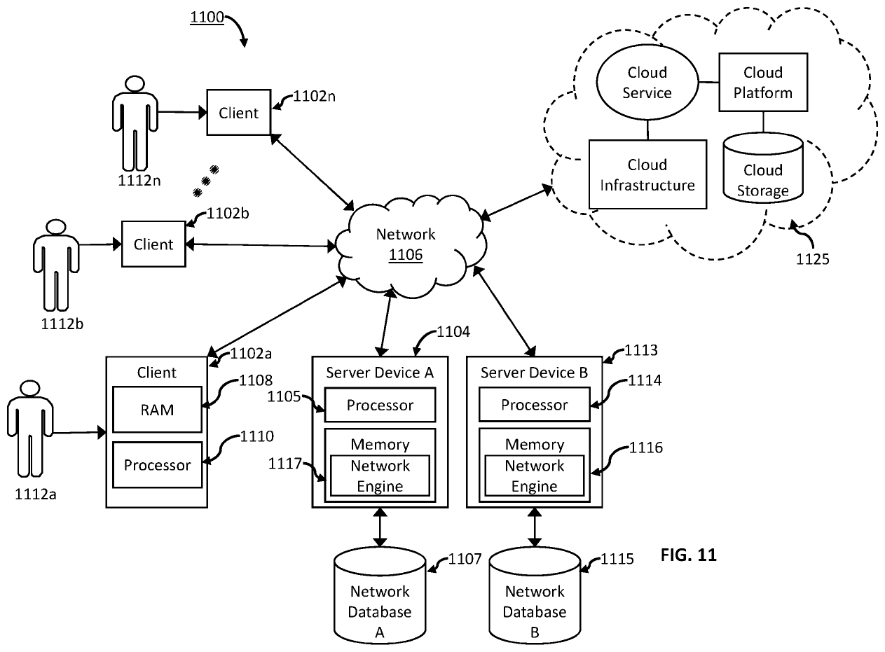

FIG. 11 depicts a block diagram of another exemplary computer-based system and platform 1100 for environmental measurement-based geolocation determination in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the client device 1102a, client device 1102b through client device 1102n shown each at least includes a computer-readable medium, such as a random-access memory (RAM) 1108 coupled to a processor 1110 or FLASH memory. In some embodiments, the processor 1110 may execute computer-executable program instructions stored in memory 1108. In some embodiments, the processor 1110 may include a microprocessor, an ASIC, and/or a state machine. In some embodiments, the processor 1110 may include, or may be in communication with, media, for example computer-readable media, which stores instructions that, when executed by the processor 1110, may cause the processor 1110 to perform one or more steps described herein. In some embodiments, examples of computer-readable media may include, but are not limited to, an electronic, optical, magnetic, or other storage or transmission device capable of providing a processor, such as the processor 1110 of client device 1102a, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc.

In some embodiments, client devices 1102a through 1102n may also comprise a number of external or internal devices such as a mouse, a CD-ROM, DVD, a physical or virtual keyboard, a display, or other input or output devices. In some embodiments, examples of client devices 1102a through 1102n (e.g., clients) may be any type of processor-based platforms that are connected to a network 1106 such as, without limitation, personal computers, digital assistants, personal digital assistants, smart phones, pagers, digital tablets, laptop computers, Internet appliances, and other processor-based devices. In some embodiments, client devices 1102a through 1102n may be specifically programmed with one or more application programs in accordance with one or more principles/methodologies detailed herein. In some embodiments, client devices 1102a through 1102n may operate on any operating system capable of supporting a browser or browser-enabled application, such as Microsoft™, Windows™, and/or Linux. In some embodiments, client devices 1102a through 1102n shown may include, for example, personal computers executing a browser application program such as Microsoft Corporation's Internet Explorer™, Apple Computer, Inc.'s Safari™, Mozilla Firefox, and/or Opera. In some embodiments, through the member computing client devices 1102a through 1102n, user 1112a, user 1112b through user 1112n, may communicate over the exemplary network 1106 with each other and/or with other systems and/or devices coupled to the network 1106. As shown in FIG. 11, exemplary server devices 1104 and 1113 may include processor 1105 and processor 1114, respectively, as well as memory 1117 and memory 1116, respectively. In some embodiments, the server devices 1104 and 1113 may be also coupled to the network 1106. In some embodiments, one or more client devices 1102a through 1102n may be mobile clients.

In some embodiments, at least one database of exemplary databases 1107 and 1115 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

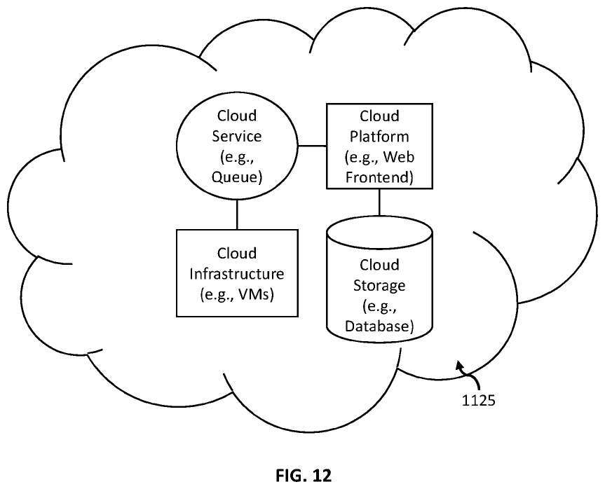

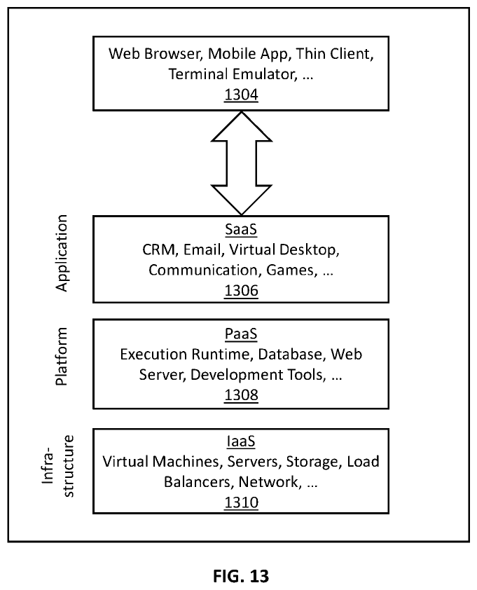

In some embodiments, the exemplary inventive computer-based systems/platforms, the exemplary inventive computer-based devices, and/or the exemplary inventive computer-based components of the present disclosure may be specifically configured to operate in a cloud computing/architecture 1125 such as, but not limiting to: infrastructure a service (IaaS) 1310, platform as a service (PaaS) 1308, and/or software as a service (SaaS) 1306 using a web browser, mobile app, thin client, terminal emulator or other endpoint 1304. FIGS. 12 and 13 illustrate schematics of exemplary implementations of the cloud computing/architecture(s) in which the geolocating system 110 for environmental measurement-based geolocation determination of the present disclosure may be specifically configured to operate.

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a user interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, several hours, daily, several days, weekly, monthly, etc.

As used herein, the term “runtime” corresponds to any behavior that is dynamically determined during an execution of a software application or at least a portion of software application.

In some embodiments, exemplary inventive, specially programmed computing systems and platforms with associated devices are configured to operate in the distributed network environment, communicating with one another over one or more suitable data communication networks (e.g., the Internet, satellite, etc.) and utilizing one or more suitable data communication protocols/modes such as, without limitation, IPX/SPX, X.25, AX.25, AppleTalk™, TCP/IP (e.g., HTTP), near-field wireless communication (NFC), RFID, Narrow Band Internet of Things (NBIOT), 3G, 4G, 5G, GSM, GPRS, WiFi, WiMax, CDMA, satellite, ZigBee. and other suitable communication modes.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of illustrative computer-based systems or platforms of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

In some embodiments, as detailed herein, one or more of the computer-based systems of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a message, a map, an entire application (e.g., a calculator), data points, and other suitable data. In some embodiments, as detailed herein, one or more of the computer-based systems of the present disclosure may be implemented across one or more of various computer platforms such as, but not limited to: (1) FreeBSD, NetBSD, OpenBSD; (2) Linux; (3) Microsoft Windows™; (4) OpenVMS™; (5) OS X (MacOS™); (6) UNIX™; (7) Android; (8) iOS™; (9) Embedded Linux; (10) Tizen™; (11) WebOS™; (12) Adobe AIR™; (13) Binary Runtime Environment for Wireless (BREW™); (14) Cocoa™ (API); (15) Cocoa™ Touch; (16) Java™ Platforms; (17) JavaFX™: (18) QNX™; (19) Mono; (20) Google Blink: (21) Apple WebKit; (22) Mozilla Gecko™; (23) Mozilla XUL; (24) NET Framework; (25) Silverlight™: (26) Open Web Platform; (27) Oracle Database; (28) Qt™; (29) SAP NetWeaver™; (30) Smartface™; (31) Vexi™; (32) Kubernetes™ and (33) Windows Runtime (WinRT™) or other suitable computer platforms or any combination thereof. In some embodiments, illustrative computer-based systems or platforms of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

In some embodiments, illustrative computer-based systems or platforms of the present disclosure may be configured to handle numerous concurrent users that may be, but is not limited to, at least 100 (e.g., but not limited to, 100-999), at least 1,000 (e.g., but not limited to, 1,000-9,999), at least 10,000 (e.g., but not limited to, 10,000-99,999), at least 100,000 (e.g., but not limited to, 100,000-999,999), at least 1,000,000 (e.g., but not limited to, 1,000,000-9,999,999), at least 10,000,000 (e.g., but not limited to, 10,000,000-99,999,999), at least 100,000,000 (e.g., but not limited to, 100,000,000-999,999,999), at least 1,000,000,000 (e.g., but not limited to, 1,000,000,000-999,999,999,999), and so on.

In some embodiments, illustrative computer-based systems or platforms of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, or objects. For example, such projections may be a visual overlay for a mobile augmented reality (MAR) application.

As used herein, the term “mobile electronic device,” or the like, may refer to any portable electronic device that may or may not be enabled with location tracking functionality (e.g., MAC address, Internet Protocol (IP) address, or the like). For example, a mobile electronic device can include, but is not limited to, a mobile phone. Personal Digital Assistant (PDA), Blackberry™, Pager. Smartphone, or any other reasonable mobile electronic device.

As used herein, terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user).

In some embodiments, the illustrative computer-based systems or platforms of the present disclosure may be configured to securely store and/or transmit data by utilizing one or more of encryption techniques (e.g., private/public key pair, Triple Data Encryption Standard (3DES), block cipher algorithms (e.g., IDEA, RC2, RC5, CAST and Skipjack), cryptographic hash algorithms (e.g., MD5, RIPEMD-160, RTRO, SHA-1, SHA-2, Tiger (TTH), WHIRLPOOL, RNGs).

As used herein, the term “user” shall have a meaning of at least one user. In some embodiments, the terms “user”, “subscriber” “consumer” or “customer” should be understood to refer to a user of an application or applications as described herein and/or a consumer of data supplied by a data provider. By way of example, and not limitation, the terms “user” or “subscriber” can refer to a person who receives data provided by the data or service provider over the Internet in a browser session or can refer to an automated software application which receives the data and stores or processes the data.

The aforementioned examples are, of course, illustrative and not restrictive.

At least some aspects of the present disclosure will now be described with reference to the following numbered clauses.

Clause 1. A method comprising:
receiving, by at least one processor, environmental sensor data from at least one environmental sensor associated with at least one Internet-of-Things (IoT) device;
   wherein the environmental sensor data comprises a plurality of environmental sensor measurements of at least one environmental condition of a local environment at a device location associated with the IoT device over a period time;
generating, by the at least one processor, an environmental sensor signature representing at least one variation of at least one characteristic of the environmental sensor data over the period of time;
accessing, by the at least one processor, environmental data in an environmental database;
   wherein the environmental data comprises a plurality of meteorological environmental measurements of at least one meteorological condition at a plurality of geographic locations over the period time:
utilizing, by the at least one processor, at least one data model to determine, based at least in part on the at least one variation of the at least one characteristic of the environmental sensor data, a degree of correlation between:
   the environmental data at each geographic location of the plurality of geographic locations, and
   the environmental sensor signature:
determining, by the at least one processor, a particular geographic location having a greatest correlation to the environmental sensor signature; and
modifying, by the at least one processor, an IoT device data record associated with the IoT device to update a device location attribute for the device location to be the particular geographic location.

Clause 2. The method of clause 1, wherein the at least one data model comprises Dynamic Time Warping.

Clause 3. The method of any one of clause 1 or clause 2, wherein:
the at least one environmental condition comprises at least one of
   pressure,
   humidity,
   temperature,
   ultra-violet index, or
   air quality; and
the at least one meteorological condition comprises at least one of
   pressure,
   humidity,
   temperature,
   ultra-violet index, or
   air quality.

Clause 4. The method of any one of the preceding clauses, further comprising:
determining, by the at least one processor, a first environmental sensor measurement at a first time;
determining, by the at least one processor, a first plurality of meteorological environmental measurements of the plurality of geographic locations at the first time; and
determining, by the at least one processor, an initial set of geographic location candidates based at least in part on the first environmental sensor measurement being within a threshold deviation of at least one meteorological environmental measurement of the first plurality of meteorological environmental measurements associated with at least one geographic location of the plurality of geographic locations.

Clause 5. The method of clause 4, wherein the threshold deviation comprises two percent.

Clause 6. The method of clause 4, further comprising:
determining, by the at least one processor, at least one subsequent environmental sensor measurement at least one subsequent time;
determining, by the at least one processor, at least one subsequent plurality of meteorological environmental measurements of the plurality of geographic locations at the at least one subsequent time; and
determining, by the at least one processor, at least one subsequent set of geographic location candidates based at least in part on the at least one subsequent environmental sensor measurement being within the threshold deviation of at least one meteorological environmental measurement of the at least one subsequent plurality of meteorological environmental measurements associated with at least one geographic location of the plurality of geographic locations; and
refining, by the at least one processor, the initial set of geographic location candidates based at least in part on the at least one subsequent set of geographic location candidates.

Clause 7. The method of clause 4, wherein the initial set of geographic location candidates comprise geographic locations along an isobar line associated with the at least one meteorological environmental measurement comprising air pressure.

Clause 8. The method of any one of the preceding clauses,
determining, by the at least one processor, at least one meteorological environmental measurement of the plurality of meteorological environmental measurements that is associated with each geographic location of the plurality of geographic locations;
determining, by the at least one processor, at least one measurement-affecting geographic feature associated with each geographic location;
   wherein the at least one measurement-affecting geographic feature causes at least one deviation to local measurement of the at least one meteorological environmental measurement;
determining, by the at least one processor, for each geographic location, at least one location-adjusted meteorological environmental measurement based at least in part on a compensation for the at least one measurement-affecting geographic feature and the at least one meteorological environmental measurement; and
utilizing, by the at least one processor, at least one data model to determine, based at least in part on the at least one variation of the at least one characteristic of the environmental sensor data, the degree of correlation between:
   the at least one location-adjusted meteorological environmental measurement at each geographic location of the plurality of geographic locations, and
   the environmental sensor signature.

Clause 9. The method of any one of the preceding clauses, further comprising:
receiving, by at least one processor, second environmental sensor data from at least one second environmental sensor associated with a second IoT device;
   wherein the second environmental sensor data comprises a second plurality of environmental sensor measurements of the at least one environmental condition of a second local environment at a second device location associated with the second IoT device over the period time;
generating, by the at least one processor, a second environmental sensor signature representing at least one second variation of at least one second characteristic of the second environmental sensor data over the period of time;
accessing, by the at least one processor, the environmental sensor signature of the at least one environmental sensor; and
determining, by the at least one processor, a relative location of the at least one second environmental sensor relative to the environmental sensor, wherein the relative location comprises a relative height within a structure associated with the IoT device.

Clause 10. The method of any one of the preceding clauses, further comprising:
generating, by the at least one processor, the environmental sensor signature based at least in part on an average of the plurality of environmental sensor measurements over the period of time; and
generating, by the at least one processor, the environment data based at least in part on an average of the plurality of meteorological environmental measurements over the period of time.

Clause 11. A system comprising:
at least one processor in communication with at least one non-transitory computer readable medium having software instructions stored thereon, wherein, upon execution of the software instructions, the at least one processor is configured to:
   receive environmental sensor data from at least one environmental sensor associated with at least one Internet-of-Things (IoT) device;
      wherein the environmental sensor data comprises a plurality of environmental sensor measurements of at least one environmental condition of a local environment at a device location associated with the IoT device over a period time;
   generate an environmental sensor signature representing at least one variation of at least one characteristic of the environmental sensor data over the period of time;
   access environmental data in an environmental database;
      wherein the environmental data comprises a plurality of meteorological environmental measurements of at least one meteorological condition at a plurality of geographic locations over the period time;
   utilize at least one data model to determine, based at least in part on the at least one variation of the at least one characteristic of the environmental sensor data, a degree of correlation between:
      the environmental data at each geographic location of the plurality of geographic locations, and
      the environmental sensor signature;
   determine a particular geographic location having a greatest correlation to the environmental sensor signature; and
   modify an IoT device data record associated with the IoT device to update a device location attribute for the device location to be the particular geographic location.

Clause 12. The system of clause 11, wherein the at least one data model comprises Dynamic Time Warping.

Clause 13. The system of any one of clause 11 or clause 12, wherein:
the at least one environmental condition comprises at least one of:
   pressure,
   humidity,
   temperature,
   ultra-violet index, or
   air quality; and
the at least one meteorological condition comprises at least one of
   pressure,
   humidity,
   temperature,
   ultra-violet index, or
   air quality.

Clause 14. The system of any one of the preceding clauses, wherein the at least one processor is further configured to:
determine a first environmental sensor measurement at a first time;
determine a first plurality of meteorological environmental measurements of the plurality of geographic locations at the first time; and
determine an initial set of geographic location candidates based at least in part on the first environmental sensor measurement being within a threshold deviation of at least one meteorological environmental measurement of the first plurality of meteorological environmental measurements associated with at least one geographic location of the plurality of geographic locations.

Clause 15. The system of clause 14, wherein the threshold deviation comprises two percent.

Clause 16. The system of clause 14, wherein the at least one processor is further configured to:
determine at least one subsequent environmental sensor measurement at least one subsequent time;
determine at least one subsequent plurality of meteorological environmental measurements of the plurality of geographic locations at the at least one subsequent time; and
determine at least one subsequent set of geographic location candidates based at least in part on the at least one subsequent environmental sensor measurement being within the threshold deviation of at least one meteorological environmental measurement of the at least one subsequent plurality of meteorological environmental measurements associated with at least one geographic location of the plurality of geographic locations; and
refine the initial set of geographic location candidates based at least in part on the at least one subsequent set of geographic location candidates.

Clause 17. The system of clause 14, wherein the initial set of geographic location candidates comprise geographic locations along an isobar line associated with the at least one meteorological environmental measurement comprising air pressure.

Clause 18. The system of any one of the preceding clauses, wherein the at least one processor is further configured to:
determine at least one meteorological environmental measurement of the plurality of meteorological environmental measurements that is associated with each geographic location of the plurality of geographic locations:
determine at least one measurement-affecting geographic feature associated with each geographic location;
   wherein the at least one measurement-affecting geographic feature causes at least one deviation to local measurement of the at least one meteorological environmental measurement;
determine for each geographic location, at least one location-adjusted meteorological environmental measurement based at least in part on a compensation for the at least one measurement-affecting geographic feature and the at least one meteorological environmental measurement; and
utilize at least one data model to determine, based at least in part on the at least one variation of the at least one characteristic of the environmental sensor data, the degree of correlation between:
   the at least one location-adjusted meteorological environmental measurement at each geographic location of the plurality of geographic locations, and
   the environmental sensor signature.

Clause 19. The system of clause 18, wherein the at least one processor is further configured to:
receive second environmental sensor data from at least one second environmental sensor associated with a second IoT device;
   wherein the second environmental sensor data comprises a second plurality of environmental sensor measurements of the at least one environmental condition of a second local environment at a second device location associated with the second IoT device over the period time;
generate a second environmental sensor signature representing at least one second variation of at least one second characteristic of the second environmental sensor data over the period of time;
access the environmental sensor signature of the at least one environmental sensor; and
determine a relative location of the at least one second environmental sensor relative to the environmental sensor, wherein the relative location comprises a relative height within a structure associated with the IoT device.

Clause 20. The system of any one of the preceding clauses, wherein the at least one processor is further configured to:
generate the environmental sensor signature based at least in part on an average of the plurality of environmental sensor measurements over the period of time; and
generate the environment data based at least in part on an average of the plurality of meteorological environmental measurements over the period of time.

While one or more embodiments of the present disclosure have been described, it is understood that these embodiments are illustrative only, and not restrictive, and that many modifications may become apparent to those of ordinary skill in the art, including that various embodiments of the inventive methodologies, the illustrative systems and platforms, and the illustrative devices described herein can be utilized in any combination with each other. Further still, the various steps may be carried out in any desired order (and any desired steps may be added and/or any desired steps may be eliminated).

What is claimed is:

1. A method comprising:
receiving, by at least one processor, environmental sensor data from at least one environmental sensor associated with at least one Internet-of-Things (IoT) device;
wherein the environmental sensor data comprises a plurality of environmental sensor measurements of at least one environmental condition of a local environment at a device location associated with the IoT device over a period time;
generating, by the at least one processor, an environmental sensor signature representing at least one variation of at least one characteristic of the environmental sensor data over the period of time;
accessing, by the at least one processor, environmental data in an environmental database;
wherein the environmental data comprises a plurality of meteorological environmental measurements of at least one meteorological condition at a plurality of geographic locations over the period time;
utilizing, by the at least one processor, at least one data model to determine, based at least in part on the at least one variation of the at least one characteristic of the environmental sensor data, a degree of correlation between:
the environmental data at each geographic location of the plurality of geographic locations, and
the environmental sensor signature;
determining, by the at least one processor, a particular geographic location having a greatest correlation to the environmental sensor signature; and
modifying, by the at least one processor, an IoT device data record associated with the IoT device to update a device location attribute for the device location to be the particular geographic location.

2. The method of claim 1, wherein the at least one data model comprises Dynamic Time Warping.

3. The method of claim 1, wherein:
the at least one environmental condition comprises at least one of:
pressure,
humidity,
temperature,
ultra-violet index, or
air quality; and
the at least one meteorological condition comprises at least one of:
pressure,
humidity,
temperature,
ultra-violet index, or
air quality.

4. The method of claim 1, further comprising:
determining, by the at least one processor, a first environmental sensor measurement at a first time;
determining, by the at least one processor, a first plurality of meteorological environmental measurements of the plurality of geographic locations at the first time; and
determining, by the at least one processor, an initial set of geographic location candidates based at least in part on the first environmental sensor measurement being within a threshold deviation of at least one meteorological environmental measurement of the first plurality of meteorological environmental measurements associated with at least one geographic location of the plurality of geographic locations.

5. The method of claim 4, wherein the threshold deviation comprises two percent.

6. The method of claim 4, further comprising:
determining, by the at least one processor, at least one subsequent environmental sensor measurement at least one subsequent time;
determining, by the at least one processor, at least one subsequent plurality of meteorological environmental measurements of the plurality of geographic locations at the at least one subsequent time; and
determining, by the at least one processor, at least one subsequent set of geographic location candidates based at least in part on the at least one subsequent environmental sensor measurement being within the threshold deviation of at least one meteorological environmental measurement of the at least one subsequent plurality of meteorological environmental measurements associated with at least one geographic location of the plurality of geographic locations; and
refining, by the at least one processor, the initial set of geographic location candidates based at least in part on the at least one subsequent set of geographic location candidates.

7. The method of claim 4, wherein the initial set of geographic location candidates comprise geographic locations along an isobar line associated with the at least one meteorological environmental measurement comprising air pressure.

8. The method of claim 1,
determining, by the at least one processor, at least one meteorological environmental measurement of the plurality of meteorological environmental measurements that is associated with each geographic location of the plurality of geographic locations:
determining, by the at least one processor, at least one measurement-affecting geographic feature associated with each geographic location;
wherein the at least one measurement-affecting geographic feature causes at least one deviation to local measurement of the at least one meteorological environmental measurement;
determining, by the at least one processor, for each geographic location, at least one location-adjusted meteorological environmental measurement based at least in part on a compensation for the at least one measurement-affecting geographic feature and the at least one meteorological environmental measurement; and
utilizing, by the at least one processor, at least one data model to determine, based at least in part on the at least one variation of the at least one characteristic of the environmental sensor data, the degree of correlation between:
the at least one location-adjusted meteorological environmental measurement at each geographic location of the plurality of geographic locations, and
the environmental sensor signature.

9. The method of claim 1, further comprising:
receiving, by at least one processor, second environmental sensor data from at least one second environmental sensor associated with a second IoT device:
wherein the second environmental sensor data comprises a second plurality of environmental sensor measurements of the at least one environmental condition of a second local environment at a second device location associated with the second IoT device over the period time;
generating, by the at least one processor, a second environmental sensor signature representing at least one second variation of at least one second characteristic of the second environmental sensor data over the period of time;
accessing, by the at least one processor, the environmental sensor signature of the at least one environmental sensor; and
determining, by the at least one processor, a relative location of the at least one second environmental sensor relative to the environmental sensor, wherein the relative location comprises a relative height within a structure associated with the IoT device.

10. The method of claim 1, further comprising:
generating, by the at least one processor, the environmental sensor signature based at least in part on an average of the plurality of environmental sensor measurements over the period of time; and
generating, by the at least one processor, the environment data based at least in part on an average of the plurality of meteorological environmental measurements over the period of time.

11. A system comprising:
at least one processor in communication with at least one non-transitory computer readable medium having software instructions stored thereon, wherein, upon execution of the software instructions, the at least one processor is configured to:
receive environmental sensor data from at least one environmental sensor associated with at least one Internet-of-Things (IoT) device;
wherein the environmental sensor data comprises a plurality of environmental sensor measurements of at least one environmental condition of a local environment at a device location associated with the IoT device over a period time;
generate an environmental sensor signature representing at least one variation of at least one characteristic of the environmental sensor data over the period of time;
access environmental data in an environmental database;
wherein the environmental data comprises a plurality of meteorological environmental measurements of at least one meteorological condition at a plurality of geographic locations over the period time;
utilize at least one data model to determine, based at least in part on the at least one variation of the at least one characteristic of the environmental sensor data, a degree of correlation between:
the environmental data at each geographic location of the plurality of geographic locations, and
the environmental sensor signature;
determine a particular geographic location having a greatest correlation to the environmental sensor signature; and
modify an IoT device data record associated with the IoT device to update a device location attribute for the device location to be the particular geographic location.

12. The system of claim 11, wherein the at least one data model comprises Dynamic Time Warping.

13. The system of claim 11, wherein:
the at least one environmental condition comprises at least one of:
pressure,
humidity,
temperature,
ultra-violet index, or
air quality; and
the at least one meteorological condition comprises at least one of:
pressure,
humidity,
temperature,
ultra-violet index, or
air quality.

14. The system of claim 11, wherein the at least one processor is further configured to:
determine a first environmental sensor measurement at a first time;
determine a first plurality of meteorological environmental measurements of the plurality of geographic locations at the first time; and
determine an initial set of geographic location candidates based at least in part on the first environmental sensor measurement being within a threshold deviation of at least one meteorological environmental measurement of the first plurality of meteorological environmental measurements associated with at least one geographic location of the plurality of geographic locations.

15. The system of claim 14, wherein the threshold deviation comprises two percent.

16. The system of claim 14, wherein the at least one processor is further configured to:
determine at least one subsequent environmental sensor measurement at least one subsequent time;
determine at least one subsequent plurality of meteorological environmental measurements of the plurality of geographic locations at the at least one subsequent time; and
determine at least one subsequent set of geographic location candidates based at least in part on the at least one subsequent environmental sensor measurement being within the threshold deviation of at least one meteorological environmental measurement of the at least one subsequent plurality of meteorological environmental measurements associated with at least one geographic location of the plurality of geographic locations; and
refine the initial set of geographic location candidates based at least in part on the at least one subsequent set of geographic location candidates.

17. The system of claim 14, wherein the initial set of geographic location candidates comprise geographic locations along an isobar line associated with the at least one meteorological environmental measurement comprising air pressure.

18. The system of claim 11, wherein the at least one processor is further configured to:
determine at least one meteorological environmental measurement of the plurality of meteorological environmental measurements that is associated with each geographic location of the plurality of geographic locations;
determine at least one measurement-affecting geographic feature associated with each geographic location;
wherein the at least one measurement-affecting geographic feature causes at least one deviation to local measurement of the at least one meteorological environmental measurement:
determine for each geographic location, at least one location-adjusted meteorological environmental measurement based at least in part on a compensation for the at least one measurement-affecting geographic feature and the at least one meteorological environmental measurement; and
utilize at least one data model to determine, based at least in part on the at least one variation of the at least one characteristic of the environmental sensor data, the degree of correlation between:
the at least one location-adjusted meteorological environmental measurement at each geographic location of the plurality of geographic locations, and
the environmental sensor signature.

19. The system of claim 18, wherein the at least one processor is further configured to:
receive second environmental sensor data from at least one second environmental sensor associated with a second IoT device;
wherein the second environmental sensor data comprises a second plurality of environmental sensor measurements of the at least one environmental condition of a second local environment at a second device location associated with the second IoT device over the period time;
generate a second environmental sensor signature representing at least one second variation of at least one second characteristic of the second environmental sensor data over the period of time;
access the environmental sensor signature of the at least one environmental sensor; and
determine a relative location of the at least one second environmental sensor relative to the environmental sensor, wherein the relative location comprises a relative height within a structure associated with the IoT device.

20. The system of claim 11, wherein the at least one processor is further configured to:
generate the environmental sensor signature based at least in part on an average of the plurality of environmental sensor measurements over the period of time; and
generate the environment data based at least in part on an average of the plurality of meteorological environmental measurements over the period of time.
